(19) United States
(12) Patent Application Publication
(10) Pub. No.: US 2006/0123577 A1
(43) Pub. Date: Jun. 15, 2006

(54) Apparatus for applying protective coatings to deck and stair balusters

(76) Inventor: Dean L. Luster, O'Fallon, MO (US)

Correspondence Address: Norman L. Wilson, Jr., P.O. Box 270448, St. Louis, MO, 63126, US

(21) Appl. No.: 11/009,582

(22) Filed: Dec. 10, 2004

(51) Int. Cl. B05C 17/00

(52) U.S. Cl. 15/210.1

(57) ABSTRACT

Applying protective coatings to deck and stair rails is not a desirable undertaking. The painting of decks with standard brushes and foam filament brushes is a time consuming task. The spacing of balusters makes the use of spray equipment impractical. The polygonal cross-sections of the balusters do not lend themselves to the use of paint rollers or painting pads. The application of protective coatings to balusters, then, has generally been a tedious operation. Herein a family of coatings applicators is provided for deck and stair balusters. The applicators include elongated rods connected at one end to form tongs. The other ends carry base plates so configured that they contact baluster surfaces when the user forces these tong ends toward each other. Paint pads are attached to the base plates so that the baluster surfaces can be readily coated.

### FIELD OF THE INVENTION

The present invention relates generally to an applicator for applying protective coatings, and in particular to paint applicators for coating deck and stair rails.

### BACKGROUND OF THE INVENTION

Exterior decks usually require moisture resistant coating compositions such as spar varnishes, polyurethane paints, and the like. Such coatings require considerable effort in order to apply them uniformly to rough, unfinished, deck balusters and rails. The painting of decks with standard brushes and foam filament brushes not only takes some time, but the process is more prone to forming undesirable bubbles in the final surface. In the coating of decks it can be quite difficult to bring the coating into contact with the outer surfaces of balusters, particularly when the decks are built well above ground level. Frequently the coating of such outer baluster surfaces can be dangerous. Even in the case of lower decks the outer surfaces of balusters can be difficult to reach. There is, then, a need for a coatings applicator for deck balusters.

Pad-type coatings applicators are not particularly desirable for coating decks because they are wider than deck balusters. They are, however, of interest herein, and they are also so well known in the art that all types need not be listed. As examples U.S. Pat. No. 6,571,418, U.S. Pat. No. 6,530,107, U.S. Pat. No. 6,456,584, U.S. Pat. No. 6,305,048, U.S. Pat. No. 6,006,393, U.S. Pat. No. 5,556,470, U.S. Pat. No. 4,819,294, U.S. Pat. No. 4,602,401, and U.S. Pat. No. 4,127,911 are given. Since they are unsuitable for such use none of these applicator references suggests a way they can be used for coating decks, particularly their balusters.

### SUMMARY OF THE INVENTION

By this invention a coatings applicator is provided in the form of a pad assembly for coating deck and stairway balusters. The assembly includes first and second elongated rods connected to each other at one end to form tongs. The tongs can be manually grasped by a user and squeezed to enable the user to force the tongs opposite free ends toward each other. Means are included for attaching base plates to the opposite tong free ends. The base plates are so configured that they contact baluster surfaces when the user forces the opposite tong free ends toward each other. Paint pads are attached to the base plates so that the baluster surfaces can be readily coated.

### THE INVENTION

The application of protective coatings to deck rails is at best a time consuming task. The balusters are normally four inches apart making the use of spray equipment impractical. In addition, since the balusters are generally narrow posts, normally having small, square, or polygonal cross-sections, they do not lend themselves to the use of paint rollers or painting pads. The application of protective coatings to balusters, then, has generally been a rather tedious operation. By this invention a family of coatings applicators is provided which renders the process much less laborious. The invention can best be understood by reference to the accompanying drawings referred to herein.

### THE DRAWINGS

FIG. 1 is an isometric view of a basic form of the invention.

FIG. 2 is an isometric view of a modification of the basic form illustrated in FIG. 1.

FIG. 3 is an isometric view illustrating the use of the assemblies of FIGS. 1 and 2.

FIG. 4 is an isometric view illustrating the best mode of the invention.

FIG. 5 is an isometric view illustrating the best mode of the invention in kit form.

FIG. 6 is an isometric view illustrating the use of kit members.

FIG. 7 is an isometric view illustrating a modification of the best mode shown in FIG. 4.

FIG. 8 is a an isometric view illustrating the use of kit members of FIG. 7.

FIG. 9 is another modification of the best mode of the invention.

### GENERAL DESCRIPTION OF THE INVENTION

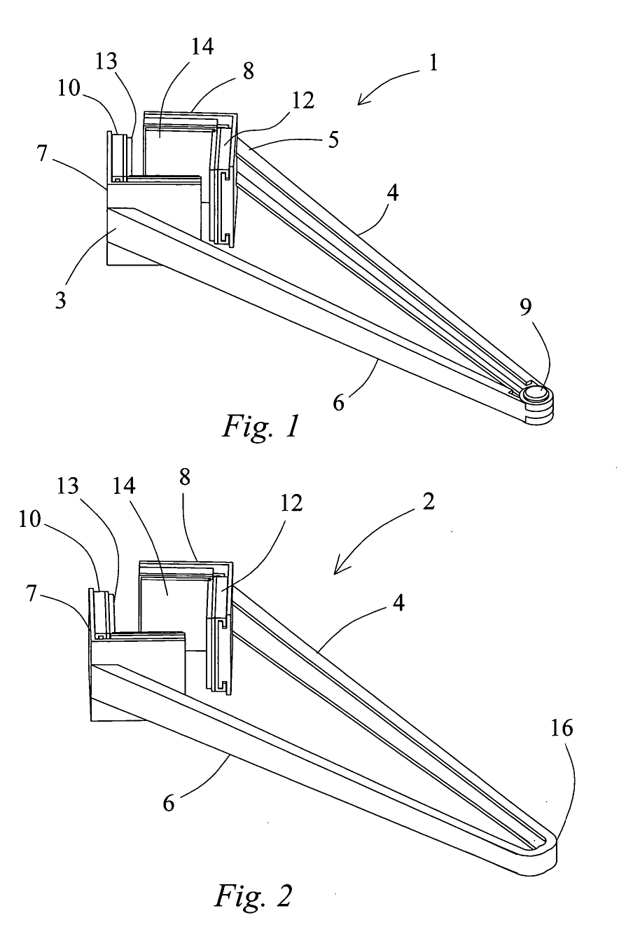

Turning now to the drawings, a basic form of the invention is illustrated in FIGS. 1 and 2. In the embodiment shown in FIG. 1 the coatings applicator 1 consists of a pad assembly having flat or round members, one in the form of a first elongated rod 4, and one in the form of a second elongated rod 6, the two rods being connected to each other by a bolt, a rivet, and the like at 9 to form tongs wherein their free ends 3 and 5 can be moved toward and away from each other as do salad tongs. Coatings applicator 1, however, differs from salad tongs in the modifications to the two opposite free ends 3 and 5 of the tongs herein. Attached to free ends 3 and 5 of the tong members are base plates 7 and 8. As shown in FIG. 1 normally the outer, side or bottom surfaces of the base plates are soldered, welded, or otherwise attached to the free ends 3 and 5 of tong members 4 and 6 so that when the tongs are squeezed by a user, the base plates are forced toward each other. Attachment of the tong members to inner base plate surfaces would present a design problem since the inner surfaces of base plates 7 and 8 are provided with means for accepting paint pads 13 and 14 that are adapted to receive the coating composition. The paint pads generally mounted on support layers 10 and 12 can be flexible plastic backing or padding layers. Such pads are well known as can be seen by referring to the patents listed hereinbefore. They are usually in the form of a foam layer, either open or closed cell foam, derived from polyurethanes or polyesters, and the foam can carry pile or bristles suitably attached to the foam layer. Some pads use bristles or other fibers to absorb and spread the coating. However pile fabrics or other piles made of nylon or natural materials have also been used and they can be found in the art. Also means for attaching the pads to base plates, such as tong and groove means shown in FIGS. 1 and 2, as well as locking tabs are known in the art, an example being U.S. Pat. No. 4,819,294. Before leaving FIG. 1 it is pointed out that base plates 7 and 8 are in the form of plane surfaces bent at right angles. The importance of this and other configurations will become apparent when the operation of the coatings applicator is discussed.

In the embodiment described in conjunction with FIG. 1 the operation of the assembly depends to a great extent upon the flexibility of the elongated rods 4 and 6 which form the tongs. Another means for providing the desired flexibility is to provide a bendable joint 16 illustrated in FIG. 2. Flexible bend 16 holds base plates 7 and 8 farther apart so that the applicator is easier to use. It can be appreciated that the flexibility of the tongs can be determined by members 4 and 6 or by bend 16.

Referring now to FIG. 3, illustrated in that figure is a portion of a deck 20 having a deck rail 24, a floor portion 31 and balusters 22. The importance of the bent or right angle plates 7 and 8 shown in FIGS. 1 and 2 can now be appreciated. It can be seen by referring to FIG. 3 that the base plates 7 and 8 are so configured that when the user forces the opposite tong free ends (See 3 and 5 in FIG. 1) toward each other, the base plates extend across all four sides of balusters 22. When the pad assembly is moved up or down along the baluster, in the manner in which paint pad units are moved along a wall above a floorboard or beside a doorjamb, a coating composition can be readily applied to all four sides of the baluster. All of the sides of the baluster are thus coated with one or a few strokes obviating the brushing of those four baluster sides.

### BEST MODE

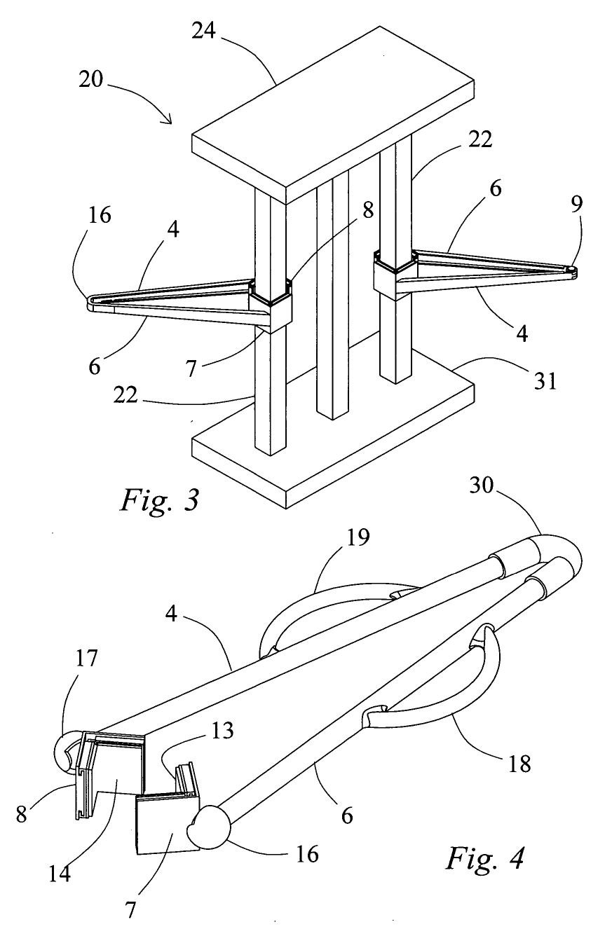

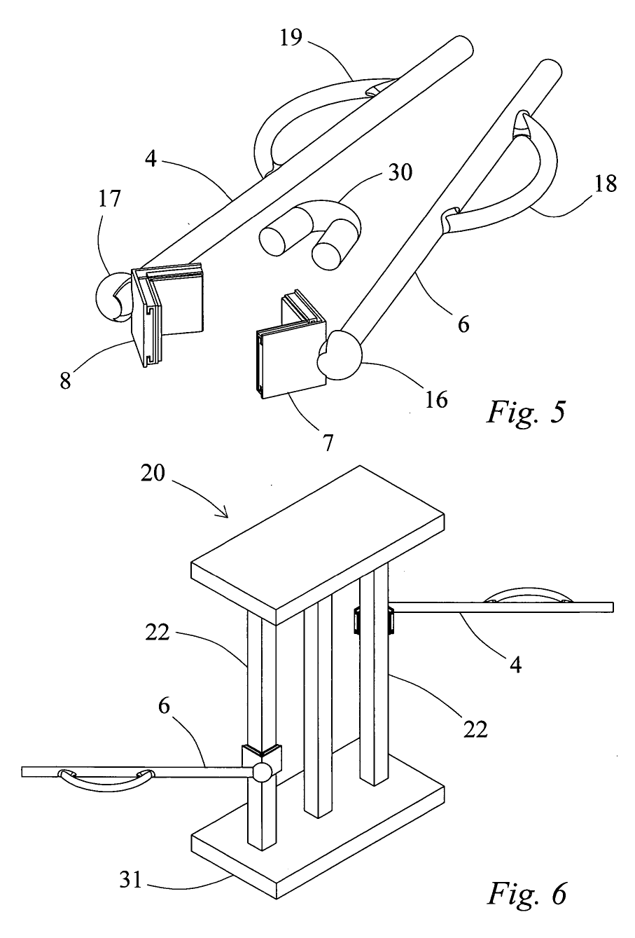

Having described the basic forms of the invention in conjunction with FIGS. 1 and 2, and their use in FIG. 3, the preferred embodiment and best mode of the invention will now be described by reference to FIG. 4. In this embodiment the flexible bend described in conjunction with FIG. 2 has been replaced with a flexible sleeve 30. This is particularly important because it enables this embodiment to be provided in kit form as illustrated in FIG. 5. The kit would include tongs 4 and 6 with their base plates 7 and 8 and flexible sleeve 30. In kit form the separation of the tongs 4 and 6 will accommodate users who, physically, or otherwise, find the use of tongs uncomfortable, awkward, or otherwise undesirable, or even too strenuous. If this is the case, the user will be able to use a rod-like single pad assembly as illustrated in FIG. 6. As can be seen, a rod-shaped member 4 or 6 can be used to coat one or more separate sides of a baluster 22. They can also be used to coat the edges of rails and deck floors. In addition, to make the coatings applicator easier to use, looped handles 18 and 19 have been attached as illustrated in FIG. 4. Such handles make it easier for the user to spread the tongs when necessary so that they will more readily envelop a baluster to contact its surfaces during the coating operation. The looped handles also make it easier to manipulate a single elongated rod member

Variations

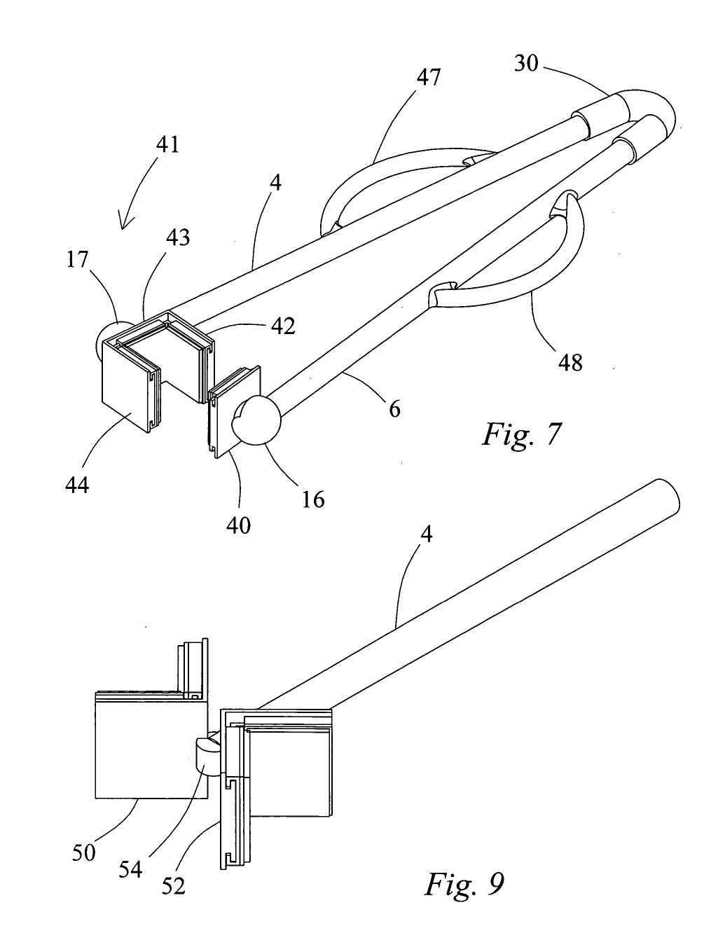

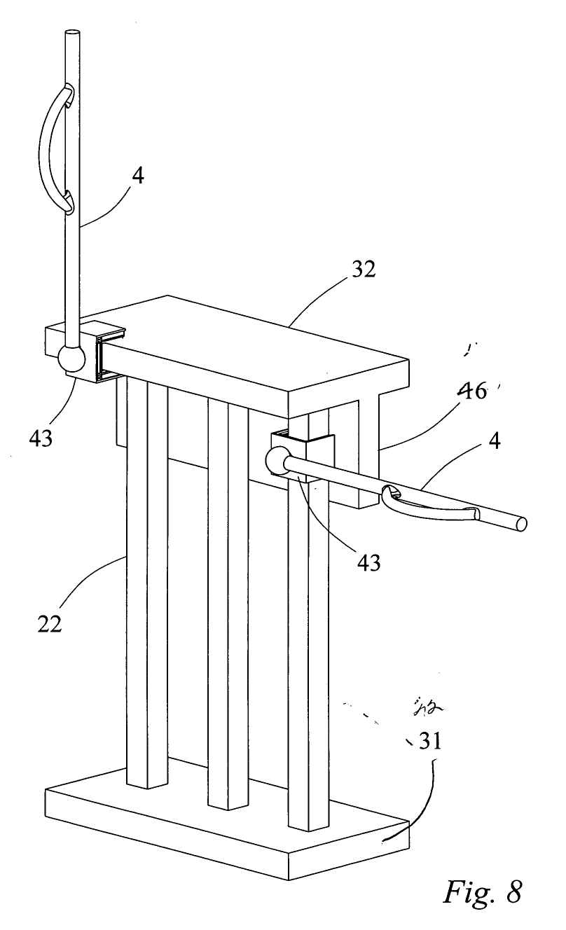

The basic aspects and components of the invention have now been described. It remains to consider some of the variations of these aspects of the invention and equivalents of the components. The most important of these equivalents is the configuration of the base plates. It is to be understood that there need not be base plates contacting only two sides of each baluster such as 7 and 8 illustrated thus far in the drawings. The base plates on one elongated rod 4 can be provided with three panels 42, 43, and 44 forming a square-cornered U illustrated on assembly 41 in FIG. 7. This configuration is adapted to coat three sides of a baluster while the other elongated rod 6 can carry only a single square plate (40, FIG. 7) adapted to coat the remaining side of the baluster. For ease of operation this assembly too is provided with looped handles 47 and 48. An advantage of this embodiment is that it is important for use in decks having a board 46 (FIG. 8) secured by nails, screws, or bolts beneath the deck rail 32. The pad assembly 41 (FIG. 7) can be run along baluster 22 in front of the board 46 up to the bottom of deck rail 32 as can be visualized by referring to FIG. 8. As shown it can also be used to coat the edges of rail 32 and deck floor 31. Further, as another embodiment of the invention the base plates of the coatings applicator can be bent or welded in the form of segments of any polygon in order to coat the surfaces of balusters with various polygonal cross-sections. The base plates can even be curved in order to coat the surfaces of balusters having circular cross sections, which can be considered polygons with infinitely short sides. The applicators of the invention can thus be used to coat circular balusters such as those supporting stair rails. In addition the three-sided base plates can be configured to fit and coat the edges of deck rails themselves and the single-sided tong can be used to coat the rail and floor between the balusters as illustrated in FIG. 8.

Another important variation of the invention concerns the desirability of having a pivotal connection, particularly a ball joint type connection, between the base plates and the elongated rod or tong member. These pivotal connections are illustrated as 16 and 17 in FIGS. 4, 5. and 7. Such a connection renders the use of the coating assembly much easier when approaching the deck from above, or the bottom of the rail from below. With a pivotal connection the plates will more readily contact the surfaces. In addition, the user's hand will be less apt to hit the other balusters as the coating is applied. It will be especially desirable to have the multiple surface base plates pivotally connected to the elongated rod free ends. Finally, still another variation of the invention is illustrated in FIG. 9. Oppositely disposed base plates 50 and 52, attached to tong element or elongated rod 4 or 6 as shown in FIG. 9, reduce coating time by enabling the device to coat adjacent balusters without recoating the pads. It can be understood, then, that such variations are within the scope of this invention.

What is claimed is:

1. As a coatings applicator, a pad assembly for coating surfaces of deck and stairway balusters, the assembly including first and second elongated rods movably connected to each other at one end to form tongs, the tongs thereby having two opposite free ends, and tong members there between that can be manually grasped by a user and squeezed to enable the user to force the opposite free ends toward each other, a plurality of base plates having inner and outer surfaces, means for attaching the base plates to the opposite tong member free ends, the base plates being so configured that when the user forces the opposite tong member free ends toward each other the base plates contact baluster surfaces, and paint pads attached to the inner surfaces of the base plates to coat those baluster surfaces.

2. The coatings applicator of claim 1 wherein the base plate on each tong member free end is a right angle plate so that when the elongated rods are forced toward each other each base plate will contact and coat two sides of a baluster having a square cross-section.

3. The coatings applicator arrangement of claim 1 wherein the base plate attached to one elongated rod is adapted to contact one side of a baluster having a square cross section, and the base plate attached to the free end of the other elongated rod is adapted to contact three sides of a baluster having a square cross section.

4. The coatings applicator of claim 1 wherein the means for attaching the opposite surfaces of the base plates to the opposite tong member free ends is a pivotal connecting means.

5. The coatings applicator of claim 4 wherein the elongated rods are held in a resilient sleeve at one end with opposite free ends thus forming tongs.

6. The coatings applicator of claim 5 wherein the first and second elongated rods carry looped handles.

7. A coatings applicator for coating sides of deck and stairway balusters having polygon cross sections comprising in kit form: a first elongated rod having one end as a free end and having its opposite end attached to a base plate in the form of panels adapted to contact at least two sides of the deck or stairway baluster; a second elongated rod also having one end as a free end but having its opposite end attached to a base plate in the form of panels adapted to contact the remaining sides of the deck or stairway baluster; and a resilient sleeve adapted to receive the free ends of the elongated rods to form tongs, the elongated rods thereby being useable as both tongs and individually.

8. The coatings applicator of claim 7 wherein paint pads are attached to the panels.

9. The coatings applicator of claim 8 wherein the means for attaching the opposite surfaces of the base plates to the opposite tong member free ends is a pivotal connecting means.

10. The coatings applicator of claim 9 wherein the first and second elongated rods carry looped handles.

11. The coatings applicator of claim 10 wherein the base plate attached to one elongated rod is adapted to contact one side of a baluster when the polygon is a square, and the base plate attached to the free end of the other elongated rod is a U-shaped plate with right angles adapted to contact the other three sides of the baluster.

12. The coatings applicator of claim 10 wherein the base plate attached to each elongated rod is adapted to contact two sides of a baluster when the polygon is a square.

13. The coatings applicator of claim 12 wherein the base plate attached to each elongated rod is adapted to contact half of the side of a baluster when the polygon is a circle.

14. The coatings applicator of claim 12 wherein one of the elongated rods has attached thereto two connected oppositely disposed back-to-back base plates having panels at right angles adapted to engage adjacent balusters without having additional paint applied to the paint pads.

15. The coatings applicator of claim 14 wherein the two back-to-back base plates are pivotally connected.
